(19) United States
(12) Patent Application Publication
(10) Pub. No.: US 2016/0136879 A1
(43) Pub. Date: May 19, 2016

(54) Susceptor Welding Tape

(71) Applicant: The Boeing Company, Chicago, IL (US)

(72) Inventors: Marc Rollo Matsen, Seattle, WA (US); Robert James Miller, Seattle, WA (US); Donald K. Dabelstein, Renton, WA (US); Lee Charles Firth, Renton, WA (US); Flint Matthew Jamison, Lynnwood, WA (US); Patrice K. Ackerman, Kent, WA (US)

(21) Appl. No.: 14/546,184

(22) Filed: Nov. 18, 2014

(51) Int. Cl. B29C 65/36; H05B 6/10

(52) U.S. Cl. CPC B29C 65/36; H05B 6/105; B29C 65/3676

(57) ABSTRACT

A susceptor welding tape for use in thermoplastic welding. The susceptor welding tape comprising a thermoplastic film and a plurality of non-continuous susceptor conductors imbedded within the thermoplastic film. The plurality of non-continuous susceptor conductors allow a resulting thermoplastic weld formed by the susceptor weld tape to be tuned to a desired engineering characteristic. For example, the plurality of conductors allow the resulting thermoplastic weld formed by the susceptor weld tape to be tuned to a desired conductivity, a desired residual stress and/or a desired moisture barrier of the resulting thermoplastic weld.

### FIELD

The present disclosure relates generally to induction welding. More particularly, the present disclosure relates to induction welding of thermoplastic composite structures using a susceptor welding tape. Such a welding tape may be used to form a thermoplastic weld having certain desired engineering characteristics, including such characteristics as weld conductance, residual stress, and moisture impedance.

### BACKGROUND

Three major joining technologies are generally used for composite structures: mechanical fastening; adhesive bonding; and welding. A thermoplastic weld is created when the thermoplastic on the surface of the two composite structures is heated to the melting or softening point and the two surfaces are brought into contact so that the molten thermoplastic mixes. Then, the surfaces are held in contact while the thermoplastic cools below the softening temperature to fuse the thermoplastic into the thermoplastic weld.

In contrast to mechanical fastening, thermoplastic welding can be advantageous as it eliminates time-consuming assembly steps and the cost and weight of mechanical fasteners. In addition, thermoplastic welding can be used to join thermoplastic composite components at high speeds with minimum touch labor and little, if any, pretreatments such as those necessary for adhesive bonding.

In certain composite welding applications, use of induction welding processes can make it difficult to obtain adequate heating at the bondline between the two graphite or carbon fiber reinforced resin matrix composites relying on the susceptibility of the fibers alone as the source of heating in the assembly. To avoid overheating of outer layers, a conductive layer or conductive article—also referred to in the relevant art as a susceptor—of significantly higher conductivity than the fibers can be used to peak the heating selectively at the bondline of the plies. An electromagnetic induction coil heats the susceptor to about the melting temperature of the thermoplastic faying surfaces of the fiber reinforced resin matrix composites so as to melt and consolidate the thermoplastic resin within the composites, thereby bonding these two elements together. Utilizing such a susceptor in the bondline can pose certain challenges in preparation and large scale manufacturing of quality parts.

There is, therefore, a need for a cost effective thermoplastic welding method that may be used to efficiently achieve a uniform, controllable temperature in the bondline resulting in high-quality and desired performance characteristics of the final bond.

### SUMMARY

According to an exemplary arrangement, a method and system for forming a thermoplastic weld utilizing a susceptor welding tape is presented. For example, in one arrangement, the susceptor welding tape comprises a thermoplastic film and a plurality of non-continuous susceptor conductors imbedded within the thermoplastic film. The plurality of non-continuous susceptor conductors allow a resulting thermoplastic weld formed by the susceptor weld tape to be tuned to a desired engineering characteristic. Such a desired engineering characteristic may comprise a conductivity of the resulting thermoplastic weld, a residual stress of the resulting thermoplastic weld, and/or a moisture barrier of the resulting thermoplastic weld.

The susceptor welding tape may further comprise a plurality of continuous susceptor conductors embedded within the thermoplastic film. In one arrangement, the plurality of non-continuous susceptor conductors are provided at a predetermined dimensional spacing within the thermoplastic film.

In another arrangement, the susceptor welding tape may define a plurality of welding tape slots. Each slot of the plurality of welding tape slots may comprise a similar geometrical configuration. As just one example, each slot of the plurality of welding tape slots may comprise a rectangular configuration. As another example, a first grouping of the plurality of welding tape slots each comprise a first geometrical configuration and a second grouping of the plurality of welding tape slots each comprise a second geometrical configuration. In such an arrangement, the first geometrical configuration may be different than the second geometrical configuration. For example, the first geometrical configuration may be a rectangular configuration and the second geometrical configuration may be a non-rectangular configuration.

In another welding tape slot arrangement, a first grouping of a plurality of welding tape slots each comprise a first size and a second grouping of the plurality of welding tape slots each comprise a second size. The first sized slots may be of a different size than the second sized slots.

In one preferred arrangement, at least one of the plurality of non-continuous susceptor conductors comprises a smart susceptor conductor. For example, the smart susceptor conductor may comprise an alloy comprising a composition in the range of from about 36% Ni to about 44% Ni in Fe. As another example, the smart susceptor conductor may comprise an alloy such as HyMu80 comprising approximately 80% Ni, 15% Fe, and 5% Mo. In addition, a material of at least one of the plurality of the non-continuous susceptor conductors may be selected from the group consisting of copper, nickel, or nickel-coated copper.

In yet another arrangement, a method for thermoplastic welding using induction is provided. The method includes the steps of providing a first composite laminate; providing a second composite laminate; and positioning a susceptor welding tape between a faying surface of the first composite laminate and a faying surface of the second composite laminate so as to define a bondline. The susceptor welding tape comprising a plurality of non-continuous conductors embedded within a thermoplastic film. The method further includes the step of heating the non-continuous conductors with an induction coil to about a melting temperature of the thermoplastic film and the faying surface of the first composite laminate and the faying surface of the second composite laminate and melting the thermoplastic film and the faying surfaces of the first and second composite laminates in contact with the susceptor tape. The method further includes the steps of allowing the melted thermoplastic film and the faying surfaces to cool; and resolidifying the thermoplastic film and the faying surfaces to form a thermoplastic weld between the first and second composite laminates.

In yet another arrangement a method of fabricating a susceptor welding tape is disclosed. This method comprises the steps of determining at least one desired engineering characteristic of a thermoplastic weld to be formed by the susceptor welding tape, and selecting the at least one desired engineering characteristic from a group of engineering characteristics comprising a thermoplastic weld conductivity, a thermoplastic weld bulk resistivity, or a thermoplastic weld moisture disruption requirement.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings, wherein:

FIG. 1 illustrates a cross-sectional view of a thermoplastic welding system according to one aspect of the present disclosure,

FIG. 2 illustrates a preferred susceptor welding tape, such as the susceptor welding tape that may be used with the thermoplastic welding system illustrated in FIG. 1;

FIG. 3 is a graph showing a correlation between conductivity and slot length of a preferred susceptor welding tape, such as the susceptor welding tape illustrated in FIG. 2;

FIG. 4A is an illustration of a block diagram of a method of processing a susceptor welding tape, such as the susceptor welding tape illustrated in FIGS. 1-2;

FIG. 4B is an illustration of a block diagram of a method of thermoplastic welding by utilizing a susceptor welding tape, such as the susceptor welding tape processed in accordance with the method illustrated in FIG. 4A;

FIG. 5 is an illustration of a perspective view of an aircraft that may incorporate one or more composite laminate structures manufactured in accordance with one or more embodiments disclosed herein;

FIG. 6 is an illustration of a flow diagram of an embodiment of an aircraft production and service method of the disclosure; and

FIG. 7 is an illustration of a functional block diagram of an aircraft.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The present disclosure generally provides for embodiments of a susceptor welding tape. The presently described susceptor welding tape provides a number of manufacturing and design advantages. For example, the presently disclosed susceptor welding tape may be provided with a plurality of non-continuous susceptor conductors that are embedded within a thermoplastic tape. This thermoplastic tape may be provided with a plurality of slots. In one preferred arrangement, each of these slots comprises a similar geometrical shape. In another preferred arrangement, each of these slots comprises a similar size. Both the predetermined number of slots and/or the geometrical shape of the slots may be selected such that the susceptor welding tape results in a thermoplastic weld that achieves a desired engineering characteristics. As just one example, the slot locations and geometries provided within the tape allow for a bulk resistivity of the resulting thermoplastic weld to be tailored or tuned so that the weld achieves a desired or targeted bulk resistivity value. Such a desired tunable bulk resistivity could be important in providing enhanced lightening strike damage resistance wherein the susceptor welding tape is used to weld composite structures that are utilized for or along an outer surface of an airplane.

In addition, susceptor welding tape slot locations and/or slot geometrical configurations may selected be designed to provide tunable values for control and manipulation of residual stress within the resulting weld. For example, the predetermined number of slots and/or the predetermined form of the slots can allow for creating variable susceptor conductor lengths within the thermoplastic tape. One such advantage of providing a variable susceptor conductor length within the susceptor tape is that it allows for creating a weld having a desired residual stress. For example, a susceptor welding tape comprising shorter susceptor conductor length's will generally produce less residual stress depending on the characteristics of the material of the susceptor alloy chosen.

Moreover, the predetermined number of slots and the predetermined form of the slots may also be used to define moisture barriers within the formed thermoplastic weld. One advantage of such moisture barriers is that they can provide a disruption in moisture paths within the thermoplastic weld. Another advantage, therefore, is that predetermined number of slots and the predetermined form of the slots will tend to inhibit the moisture absorption and potential damage to the weld.

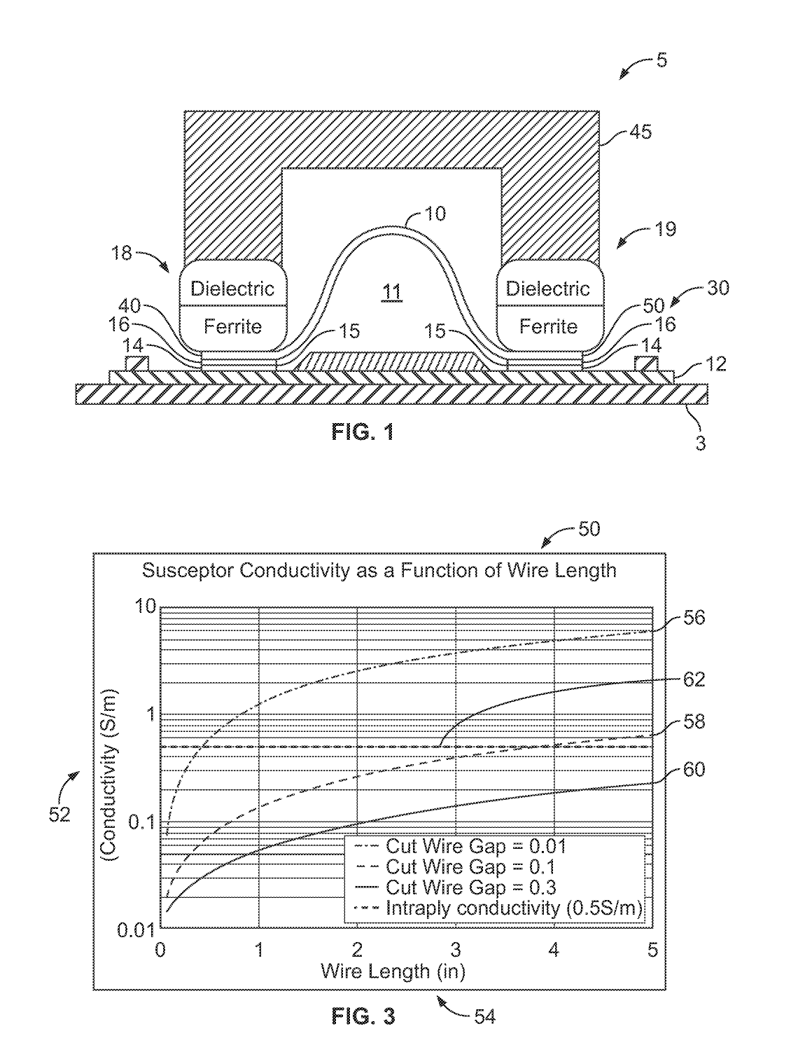

The present disclosure will be described more fully hereinafter with reference to the accompanying drawings, in which preferred embodiments of the disclosure are shown. For example, FIG. 1 illustrates a cross-sectional view of a thermoplastic welding system 5 according to one aspect of the present disclosure. Specifically, FIG. 1 shows a first composite laminate 10 of graphite fiber reinforced thermoplastic composite material provided above a second composite laminate structure 12. Preferably, the second composite laminate structure 12 will comprise a similar composition to the first composite laminate 10. In this illustrated arrangement, the second composite laminate structure 12 is provided along a top surface of a tool 3. As illustrated, the first composite laminate 10 may comprise a hat shaped stringer and the second composite structure 12 may comprise a skin panel. However, as those of ordinary skill in the art will recognize, alternative first and second composite laminate structures may be welded together by way of the presently disclosed thermoplastic welding system 5.

In FIG. 1, a susceptor 14 (or conductive element) is positioned along a top surface of the composite laminate structure or skin panel 12. In addition, a layer of thermoplastic 16 is positioned over a top surface of the susceptor 14 and a bottom surface of the first composite laminate or hat shaped stringer 10. In this illustrated arrangement, the first composite laminate 10 is a stringer that comprises a hat section forming an internal stringer cavity 11 and a pair of laterally extending flange sections 40, 50, that will be welded onto the second composite laminate 12 that is a skin panel by induction heat created by the two induction coils 18 and 19. Preferably, the susceptor 14 is embedded within the thermoplastic such that the susceptor 14 and thermoplastic 16 together define a susceptor welding tape 30. It is this susceptor welding tape 30 that defines a bondline 15 for forming a thermoplastic weld between the first composite laminate 10 to the second composite laminate 12.

To inductively weld the first composite laminate 10 to the second composite laminate 12, as just one example of such a heating process, a first and a second induction coil 18, 19 may be used to weld the two contact points of the first and second composite laminates, being the two extending flanges 40 and 50. The first induction coil 18 is positioned above the first extending flange 40 of the hat 10 and the second induction coil 19 is positioned above the second extending flange 50 of the hat 10. In one preferred configuration, the induction coils 18, 19 comprise a dielectric and ferrite core wherein a Litz wire is spirally wound along an outer surface of the coil core. In addition, a welding frame 45 may be provided for holding the first and second coils 18, 19 in place and also for applying pressure during the welding process.

By energizing the induction coils 18 and 19, the coils will excite or induce eddy currents in the susceptor 14. These eddy currents will heat the assembly under the coils 18, 19 to a temperature required to melt and cure the thermoplastic resin 16 within the susceptor tape 30, thus forming the desired thermoplastic weld. In one arrangement, current in the coils induces eddy currents in the susceptor 14 in proportion to the oscillating magnetic field strength.

In one preferred arrangement, the coils may be excited by a power source having a frequency of approximately from about 150 kHz to about 300 KHz for generating magnetic fields that are substantially parallel to the axis of the smart susceptor wires. This substantially parallel oscillating magnetic field generates currents that travel circumferentially in the smart susceptor wire. When the smart susceptor wire nears its Curie point or Curie temperature, there is a significant loss in the smart susceptor's magnetic properties. This leads to a substantial increase in the depth of the induced current. This leads to appreciable current cancellation and a sharp leveling of the wire temperature occurs.

When energized, the induction coils will heat the susceptor to about the melting temperature of the thermoplastic faying surfaces of the first composite laminate 10 and second composite laminate 12. The thermoplastic 16 encapsulating the susceptor melts and composite laminates 10, 12 in contact with the susceptor tape also melts. Pressure may be exerted on the composites by way of the welding frame 45, thereby pressing the faying surfaces closer together. After a desired amount of heat and pressure has been provided for a desired amount of time by way of the coils 18, 19, the first and second composites are allowed to cool. After a sufficient amount of cooling time, the first and second composite laminates 10, 12 are now welded together with some percentage of the bondline faying surfaces welded together thereby forming the thermoplastic weld.

The composite laminates 10, 12 that therefore joined with the susceptor welding tape 30 are typically the same materials and are typically prefabricated before this thermoplastic welding via the susceptor welding tape 30 occurs. As one example, the first and second composite structures may comprise a composite comprising a carbon or graphite fiber reinforced polyether ether ketone PEKK that has a melt temperature of 337° C. (639° F.° F.). In one preferred process step, the surfaces of the composite laminates are complimentary profiled to help ensure a weld free from voids.

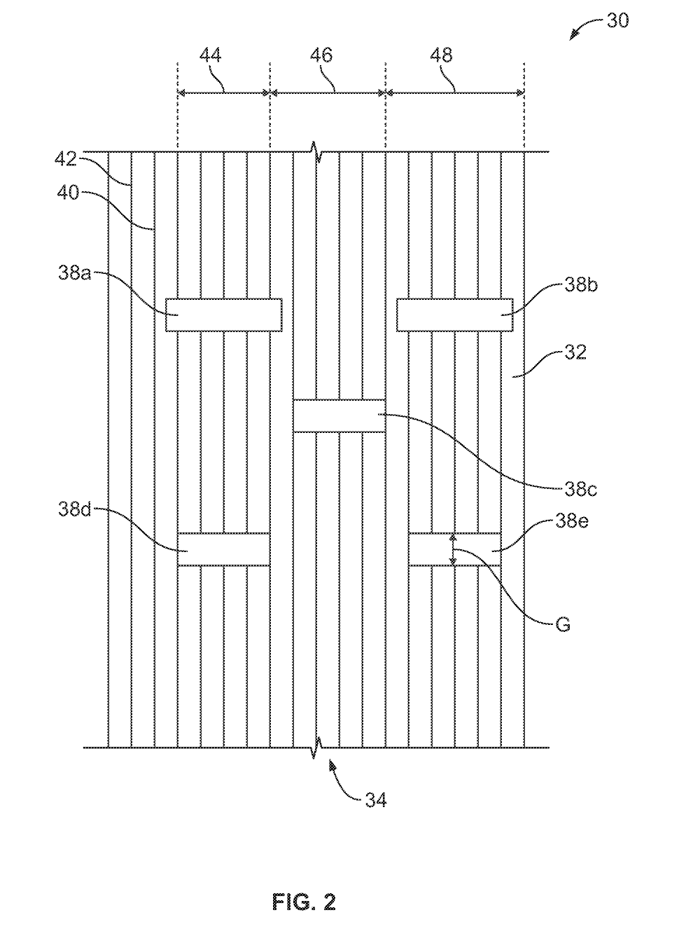

FIG. 2 illustrates an enlarged view of an exemplary susceptor welding tape 30, such as the welding tape 30 used with the thermoplastic welding system 5 illustrated in FIG. 1. As illustrated, the susceptor welding tape 30 comprises a thermoplastic 32 and a plurality of non-continuous conductors 34 embedded within this thermoplastic 32. In this exemplary illustrated arrangement, the susceptor welding tape 30 comprises fifteen non-continuous conductors 34. Additionally, the susceptor welding tape 30 may also comprise continuous conductors wherein such conductors are continuous along the entire length of the tape. As illustrated, the susceptor welding tape 30 comprises two continuous conductors 40, 42 that extend from a first end to the second end of the welding tape 30. As those of skill in the art will recognize, alternative conductor arrangements may also be used. As just one example, more or less than fifteen non-continuous conductors may be used.

Preferably, the thermoplastic 32 comprises a thermoplastic film. As just one example, the thermoplastic film comprises a thermoplastic such as polyyimide, polyetheretherketone (PEEK), or polyetherketoneketone (PEKK). However, alternative thermoplastic materials may also be used. In one preferred arrangement, the susceptor welding tape 30 may comprise a thickness of about 0.010 in (0.25 mm).

Importantly, the susceptor welding tape 30 is processed so as to define a plurality of slots within the tape 30 thereby providing for the non-continuous nature of the conductors 34 within the tape 30. As just one example, in the exemplary susceptor welding tape 30 illustrated in FIG. 2, five (5) slots 38 (a-e) are provided. This plurality of slots 38 (a-e) may be punched into the susceptor welding tape 30. In one preferred arrangement, the plurality of slots 38 (a-e) are arranged within the welding tape 30 in a unified manner or predetermined pattern. As illustrated, each individual slot within this plurality of slots 38 (a-e) comprises a slot of uniform shape. In addition, and as illustrated, each individual slot within this plurality of slots 38 (a-e) comprises a uniform size. That is, each of the slots 38 (a-e) comprises a rectangular slot and each rectangular slot has a similar length and a similar width.

However, as those of ordinary skill in the relevant art will recognize, alternative slot configurations and slot geometries may also be used. As just one example, a non-uniform slot arrangement may be used. For example, the plurality of slots may comprise a first plurality of slots comprising a first rectangular size and the plurality of slots may comprise a second plurality of slots comprising a second rectangular size where the second rectangular size may be larger or smaller than the first rectangular size. Those of ordinary skill in the art will recognize alternative slot configurations may also be used. As will be described in greater detail herein, alternative slot configurations may be used to tune or tailor the bulk residual stresses of the thermoplastic weld formed between a first composite laminate and a second composite laminate so as to match that of the surrounding composite material. Additionally, alternative slot geometrical configurations, orientations and hence conductor lengths can be engineered so as to reduce the residual stress to a desired level for the composite laminate structure being fabricated. Another advantage of certain alternative slot configurations of the disclosed susceptor weld tape is the prevention of bond joint moisture wicking.

In one preferred arrangement, the inductors comprise a conductor length of no less than 0.250″ in length. The maximum length may be governed by the constraints as defined by the residual stress, bulk resistivity and the elimination of moisture ingression as discussed herein. One advantage of such a various sized slot configurations is that the resulting length of the various conductors 34 within a specific group will comprise conductors of dissimilar lengths, thereby allowing the resulting engineering characteristics of the susceptor welding tape 30 to be tuned or tailored to a meet certain desired engineering specifications.

Alternatively, the susceptor welding tape 30 may comprise a plurality of slots wherein various slot geometrical shapes may be used. For example, a susceptor welding tape may comprise both rectangular slots along with non-rectangular slots (e.g., circular slots, triangular slots, oval slots, elliptical slots, etc.). As just one example, the plurality of slots may comprise a first set of slots comprising a first geometrical shape and the second plurality of slots may comprise a second set of slots comprising a second geometrical shape wherein the second set of slots may be different than the geometrical shape of the first set of slots. As those of ordinary skill in the art will recognize, alternative slot geometrical configurations may also be used.

In this illustrated arrangement, all the embedded conductors within the susceptor welding tape 30 comprise parallel embedded conductors. That is, all of the embedded conductors within the plurality of conductors 34 are positioned parallel with one another. However, as those of skill in the art will recognize, alternative conductor arrangements may be used. As just one example, non-parallel conductors may also be used. Alternatively, one or more layers of embedded conductors and/or thermoplastic may also be used.

The plurality of susceptor conductors 34 provided or embedded within the thermoplastic 32 of the susceptor welding tape 30 may all comprise a common alloy. As just one example, the plurality of susceptor conductors 34 may comprise a material that provides a desired electrical conductivity. For example, such susceptor conductors 34 may comprise copper, nickel, or nickel-coated copper conductors. Again, in an alternative arrangement, all of the susceptor conductors comprise the same type of susceptor material, such as copper, nickel, or nickel-coated copper.

In alternative welding tape arrangements, a first plurality of susceptor conductors may comprise a first alloy material while a second plurality of susceptor conductors may comprise a second allow material that is different than the first alloy material. As just one example, referring now to FIG. 2, a first group of conductors 44 may comprise a first material (e.g., copper) while a second group of conductors 46 may comprise a second and different material (e.g., nickel). The third grouping of conductors 48 may comprise a metal alloy similar to the first group 44, similar to the second group 46, or perhaps an alloy different from both the first and the second groups 44, 46. And a fourth group of conductors, such as the continuous conductors 40 and 42, may comprise yet a fourth type of allow or material. Again, as those of ordinary skill in the art will recognize, alternative conductor material arrangements within the susceptor welding tape 30 may also be used.

In one preferred, arrangement, the material of at least one of the plurality of conductors 34 comprises a “smart” susceptor material. In other words, in one preferred arrangement, the material of the susceptor conductors 34 may comprise a magnetic alloy that has a high magnetic permeability but that also have their magnetic permeability's fall to unity at their Curie temperature. At the Curie temperature, then, the susceptors become inefficient heaters. As such, smart susceptor magnetic alloys are typically selected to have Curie points close to the process temperature of welding. With the present disclosure, such smart susceptor magnetic alloys may be selected to have low thermal expansion coefficients so as to match the thermal expansion of that composite structures being welded. As just one example, susceptor alloys comprising a composition range of from about 36% Ni to about 44% Ni in Fe. The conductor material may be chosen for the conductors 34 having a coefficient of thermal expansion (CTE) that essentially matches the CTE of the composite and a process control temperature based on the magnetic properties of about 710° F. (377° C.), which is acceptable for thermoplastic welding of thermoplastics like PEKK since it is slightly above the thermoplastics' melting point. Additional alloying elements such as Al, Cb, and Ti may also be used. In addition, the alloy element HyMu80 (80% Ni, 15% Fe, 5% Mo) may be used as well.

The plurality of conductors 34 provided or embedded within the thermoplastic 32 of the susceptor welding tape 30 may all comprise a common thickness. As just one example, the plurality of conductors 34 may comprise a common conductor thickness. For example, such a common conductor thickness may comprise a thickness of about from 0.003 to 0.010 inches (0.075-0.25 mm). In an alternative arrangement, the plurality of conductors 34 of the susceptor welding tape 30 may comprise one or more conductors having variable thicknesses. As just one example, the first set of conductors 44 may have a first thickness and the second set of conductors 46 may have a second thickness, wherein the second thickness may be greater than or less than the first thickness. Similarly, the third set of conductors 48 may comprise a third thickness that is different than the thickness of the first and second group. Similarly, the thickness of the continuous conductors 40, 42 may also have a different thickness as the other conductors 34 within the welding tape 30 as well. As those of ordinary skill in the art will recognize, alternative susceptor conductor thickness arrangements may also be used.

Lightning protection of composite structures, such as carbon fiber reinforced plastic fabricated by the system illustrated in FIG. 1, can be more complicated due to its higher electrical resistance and multi-layer construction. When lighting attaches to composite surfaces, the lightning current tends to be high at the surface penetrating metal fasteners attached to underlying substructure. Therefore, it is desirable to shield or other protect certain types of composite skin from current and voltage surges from a lightning strike. One advantage of the susceptor welding tape as disclosed herein, such as the susceptor welding tape 30 illustrated in FIGS. 1 and 2, offers enhanced lightening strike protection.

For example, the disclosed susceptor welding tape 30 comprises a desirable protective technology in that it is relatively straightforward to implement in routine manufacturing processes, such as during the fabrication of aircraft composite structures. That is, the susceptor welding tape 30 can be fabricated with desired conductor materials and then the tape can be processed or punched to provide for desired slot configurations.

Certain conventional smart susceptor conductors that may be used in susceptor welding tapes can have an electrical resistivity of approximately 60 to 120 μohm-cm. As those of ordinary skill in the art recognize, susceptor electrical resistivity will be dependent on the chemistry of the susceptor material used. In contrast, thermoplastic composites can have electrical resistivity's that are significant higher than certain susceptor conductors. For example, typical thermoplastic composites may have an electrical resistivity on the order from about 1,000 to about 10,000 μohm-cm. These electrical resistivity values are dependent on the fiber and matrix combinations. By utilizing the presently disclosed susceptor welding tape arrangements comprising non-continuous conductors as discussed and illustrated herein, the bulk lateral resistivity of the resulting thermoplastic weld formed between a first composite structure and a second composite structure can be tuned or tailored so as to match a desired bulk lateral resistivity, such as the bulk lateral resistivity of the surrounding composite material.

For example, referring back to FIG. 1, the material of the susceptor 14 may be selected to match either the material of the first composite laminate 10 or the second composite laminate 12. As such, it may be lower than the surrounding materials, or be higher than the surrounding materials. As just one example, referring to the susceptor tape 30 illustrated in FIG. 2, an overall bulk lateral electrical resistivity of the susceptor 14 may be tuned or tailored by controlling the frequency of the slots and/or the dimension of the slots. By controlling the frequency and/or dimension of the slots provided within the susceptor welding tape 30, this in essence will control a gap residing between conductor segments. Furthermore, the tunable nature of the joint can hold advantages when engineering EME solutions. For example, preventing damage from a lighting strike attachment and subsequent current flow is a major concern for aircraft made of carbon fiber laminates. A highly conductive susceptor may concentrate lightning currents in the joint, possibly damaging the joint. Tuning the susceptor conductivity to values that are similar to the welded laminates eliminates the possibility that the susceptor in the joint is a preferential path for lightning currents. For example, the tunable nature of the thermoplastic weld can be achieved by defining a predetermined gap (See, e.g., FIG. 2 and gap G from slot 38e) that resides between a first grouping of conductors residing above slot 38e and a second grouping of conductors residing below this slot 38e.

FIG. 3 is a graph 50 showing susceptor tape conductivity 52 (i.e., Siemens per meter S/m) as a function of conductor length 54 (conductor length provided in inches). Generally, as illustrated, three susceptor weld tape configurations are graphed. In the first susceptor welding tape configuration 56, a cut conductor gap G of 0.01 was used. As shown, such a configuration has a bulk lateral conductivity that is greater than a typical composite intraply conductivity of 0.5 S/m. In the second susceptor weld tape configuration 58, a conductor gap G of 0.1 was used. As shown, this second weld tape configuration closely resembles the intraply conductivity of 0.5 S/m at certain conductor lengths (approximately 4-5 inches). In the third susceptor weld tape configuration, a conductor gap G of 0.3 was used. As evidence from these three exemplary graphs, the overall susceptor tape conductivity can be tuned or tailored to either increase or decrease as a function of the gap (“G”) size residing between conductor groupings. Increasing the gap size will generally decrease the welding tape bulk lateral conductivity while decreasing the gap size will generally increase the welding tape bulk lateral conductivity.

Residual stresses can play a significant role in composite material failure. A common example is that fiber-matrix de-bonding and pullout are significantly affected by the residual stress normal to the fiber-matrix interface. Other performance characteristics have also been found to be affected by residual stress, including matrix cracking, yield strength and dimensional stability. Utilizing the presently disclosed susceptor welding tape arrangements allows the bulk residual stresses of the thermoplastic weld formed between a first composite structure and a second composite structure to be tuned or tailored so as to match that of the surrounding composite material.

For example, typical susceptor conductors can have coefficients of thermal expansion (CTE) between 5.0 and 7.0 micro in./in.-F. In contrast, the coefficient of thermal expansion of certain conventional carbon fiber reinforced thermoplastic composites can have significantly lower coefficients of thermal expansion, such as between 0.5 and 1.5 micro in./in.-F. As such, the CTE of typical susceptor conductors may be on the order of almost ten times greater than that of the surrounding composite structure.

Such differences between the CTEs can produce unwanted residual stresses within thermoplastic welded structures. For example, this difference can produce residual stresses as the thermoplastic weld cools from approximately 710° F. The longer the length of susceptors conductors residing within the susceptor weld tape, the higher the peak residual stress associated with this CTE mismatch. (typically at the wire ends). Therefore, depending on factors such as the weld temperature associated with the thermoplastic and the smart susceptor chemistry, an optimal conductor length and hence the slot locations can be calculated. As such, conductor length and slot geometrical configuration and orientation as discussed herein can be designed so as to reduce the residual stress to a desired level for the structure being fabricated.

Another advantage of the presently disclosed embodiments is that the disclosed susceptor weld tape may be used to prevent bond joint moisture wicking. Moisture can cause serious problems in bonded composite structures. For example, as is generally known, graphite and epoxy laminates may absorb up to 1.5% moisture during exposer in certain humid operating environments. Moisture absorption by the composite laminate can generally result in two fundamental issues: a decrease in matrix-denominated mechanical property values and changes in composite laminate physical dimensions. The moisture is actually absorbed by the epoxy matrix where it reduces some thermoplastic sensate mechanical properties, such as compressive strength at elevated temperatures. Moisture can also be trapped in voids, delamination, and bondlines where it can cause severe damage due to expansion effects in a thermal spike exposure or in a freeze/thaw cycle.

The use of a susceptor welding tape with an assortment of slots as disclosed herein will help to eliminate the continuous pathway into the thermoplastic weld and thereby act to disrupt or limit the ability of moisture to migrate into the resulting bonded joint.

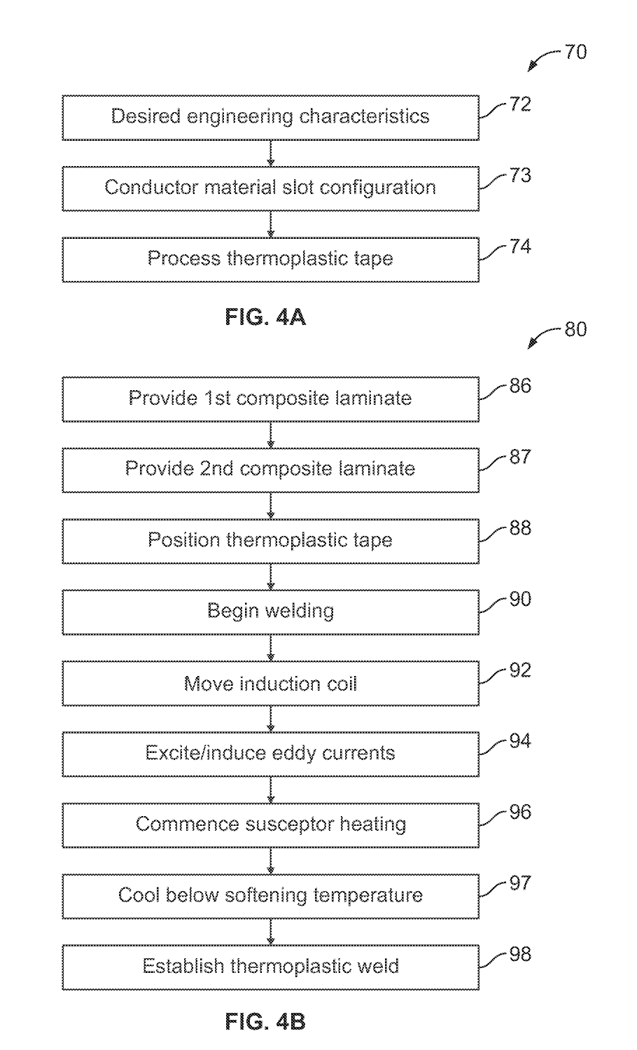

FIG. 4A is an illustration of a block diagram of a method 70 of fabricating a susceptor welding tape, such as the susceptor welding tape illustrated in FIGS. 1-2. For example, this method 70 of fabricating a thermoplastic welding tape may begin at Step 72. At Step 72, the desired engineering characteristics of the thermoplastic weld are determined. As mentioned above, these engineering characteristics may include (but may not be limited to) the thermoplastic weld's conductivity, bulk resistivity, and/or moisture disruption requirements. The method 70 of fabricating the thermoplastic welding tape may further include Step 73. At Step 73, the conductor material and/or slot structure and geometry of the susceptor welding tape are defined based on these desired engineering characteristics. As described herein in greater detail, these desired engineering characters could include the conductor length, the number and size of the slots, the slot's geometrical configuration or configurations, and the type of susceptor material used (typical alloy(s) or smart alloy(s)). Then, at Step 74, the welding tape is processed or manufactured in order to achieve the desired susceptor conductor orientation and/or slot configuration.

FIG. 4B is an illustration of a block diagram of a method 80 of thermoplastic welding by utilizing a susceptor welding tape, such as the susceptor welding tape processed or manufactured in accordance with the method 70 illustrated in FIG. 4A. The method 80 begins at Step 86, where the method includes the step of providing a first composite laminate. Such a first composite laminate may comprise a graphite fiber reinforced thermoplastic composite material. At Step 87, the method 80 includes the step of providing a second composite laminate. Such a second composite laminate may comprise a graphite fiber reinforced thermoplastic composite material. At Step 88, the method includes the step of positioning a susceptor welding tape (such as, for example, a susceptor welding tape processed in accordance with the method 70 illustrated in FIG. 4A) between a faying surface of the first composite laminate and a faying surface of the second composite laminate. It is this susceptor welding tape that will form a bondline for welding the faying surface of the first composite laminate to the faying surface of the second composite laminate.

At Step 90, the thermoplastic welding process begins. To weld the first composite laminate to the second composite laminate, at Step 92, power is provided to one or more induction coils that are moved into position at or near one or more bondlines. At Step 94, the induction coil excites or induces eddy currents in the susceptor so as to heat the assembly under the coil to a temperature required to melt and cure the thermoplastic within the susceptor welding tape. Current in the coil induces eddy currents in the susceptor in direct proportion to the oscillating magnetic field strength. At Step 96, commencement of susceptor heating begins because of the flow of the eddy currents through the susceptor. Preferably, the coil is energized for a certain period of time at or near the bondline in order to heat the susceptor to about the melting temperature of the thermoplastic faying surfaces of the first composite laminate and second composite laminate. The thermoplastic encapsulating the susceptor melts and the composite laminates in contact with the susceptor tape also melts. At Step 97, the surfaces of the first and second composite laminates are held in contact with one another while the heated thermoplastic cools below the softening temperature so as to fuse the thermoplastic into the thermoplastic weld. During Step 97, pressure may be exerted on the first and second composites to press the faying surfaces closer together. After a desired amount of heat and pressure has been provided for a desired amount of time by way of the coils, the first and second composites are allowed to cool. After a sufficient amount of cooling time, the first and second composite laminates are now welded together with some percentage of the bondline faying surfaces welded together thereby forming the thermoplastic weld.

At Step 98, the desired thermoplastic weld having the desired engineering characteristics is established. As just one example, at Step 98, the desired thermoplastic weld having the desired engineering characteristics as determined at Step 72 in the method 70 illustrated in FIG. 4A is established.

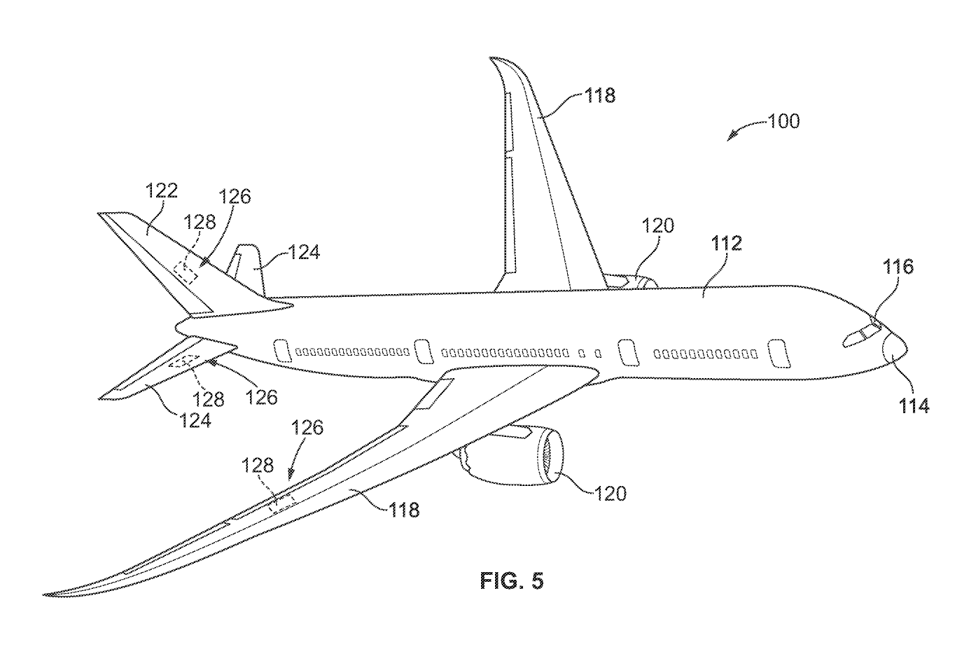

FIG. 5 is an illustration of a perspective view of an aircraft 100 that may incorporate one or more composite laminate structures welded together by one of the susceptor welding tap embodiments of the present disclosure. As shown in FIG. 5, the aircraft 100 comprises a fuselage 112, a nose 114, a cockpit 116, wings 118 operatively coupled to the fuselage 120, one or more propulsion units 120, a tail vertical stabilizer 122, and one or more tail horizontal stabilizers 124. Although the aircraft 100 shown in FIG. 5 is generally representative of a commercial passenger aircraft, the one or more composite laminates, as disclosed herein, may also be employed in other types of aircraft or air vehicles. More specifically, the teachings of the disclosed embodiments may be applied to other passenger aircraft, cargo aircraft, military aircraft, rotorcraft, and other types of aircraft or aerial vehicles, as well as aerospace vehicles, satellites, space launch vehicles, rockets, and other aerospace vehicles. It may also be appreciated that embodiments of structures and methods in accordance with the disclosure may be utilized in other transport vehicles, such as boats and other watercraft, trains, automobiles, trucks, buses, or other suitable transport vehicles formed from or utilizing the composite laminates as disclosed herein.

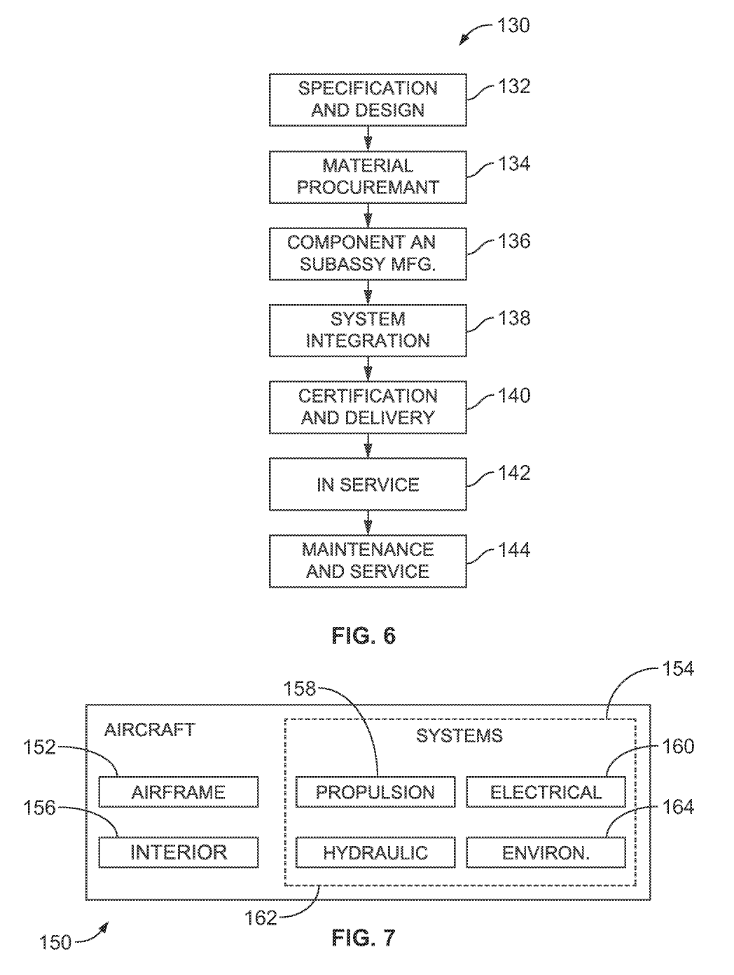

Embodiments of the disclosure may find use in a variety of potential applications, particularly in the transportation industry, including for example, aerospace, marine, automotive applications and other application where thermoplastic composite tubular structures may be used. Therefore, referring now to FIGS. 6 and 7, embodiments of the disclosure may be used in the context of an aircraft manufacturing and service method 130 as shown in FIG. 6 and an aircraft 150 as shown in FIG. 7. Aircraft applications of the disclosed embodiments may include, for example, without limitation, the design and fabrication of composite laminates fabricated by way of a releasable support as disclosed herein.

During pre-production, exemplary method 130 may include specification and design 132 of the aircraft 150 and material procurement 134. As just one example, for the specification and design of the aircraft related composite laminates, the desired engineering characteristics of the thermoplastic weld may be determined at this step (see, e.g., Step 72 FIG. 4). As just one example, at this step, this might include the selection of material type of susceptor conductor or conductors may be determined at this step. In addition, the configuration and geometry of the slots may also be determined at this step.

As another example, during this specification and design step, in one particular composite laminate arrangement, the thickness of the welding tape or the thickness of the susceptor or susceptors may be determined. In addition, during this specification and design step, the use of one or more different conductors within the tape may be determined. As just another example, at this design step, it may be determined that both continuous and non-continuous conductors are to be employed in the welding tape. As just another example, at this design step, it may be determined that one or more than one slot geometries will be used for the welding tape.

During production, component and subassembly manufacturing 136 and system integration 138 of the aircraft 150 takes place. As will be explained in greater detail above, FIGS. 1-4 illustrate one preferred type of process steps for fabricating composite laminate utilizing a releasable underlying support in accordance with one aspect of the present disclosure. After such a component and subassembly manufacturing step, the aircraft 150 may go through certification and delivery 140 in order to be placed in service 142. While in service by a customer, the aircraft 150 is scheduled for routine maintenance and service 144, which may also include modification, reconfiguration, refurbishment, and so on.

Each of the process steps of method 150 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 7, the aircraft 150 produced by exemplary method 130 may include an airframe 152 with a plurality of high-level systems 154 and an interior 156. Examples of high-level systems 154 may include one or more of a propulsion system 158, an electrical system 160, a hydraulic system 162, and an environmental system 164. Any number of other systems may be included. Although an aerospace example is shown, the principles of the disclosure may be applied to other industries, such as the marine and automotive industries.

Systems and methods embodied herein may be employed during any one or more of the stages of the production and service method 130. For example, components or subassemblies corresponding to production process may be fabricated or manufactured in a manner similar to components or subassemblies produced while the aircraft 150 is in service. Also, one or more apparatus embodiments, method embodiments, or a combination thereof may be utilized during the production stages 132 and 134, for example, by substantially expediting assembly of or reducing the cost of an aircraft 150. Similarly, one or more of apparatus embodiments, method embodiments, or a combination thereof may be utilized while the aircraft 150 is in service, for example and without limitation, to maintenance and service 144.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

We claim:

1. A susceptor welding tape for use in thermoplastic welding, the susceptor welding tape comprising:
a thermoplastic film; and
a plurality of non-continuous susceptor conductors imbedded within the thermoplastic film,
wherein the plurality of non-continuous susceptor conductors allow a resulting thermoplastic weld formed by the susceptor weld tape to be tuned to a desired engineering characteristic.

2. The susceptor welding tape of claim 1 further comprising
a plurality of continuous susceptor conductors embedded within the thermoplastic film.

3. The susceptor welding tape of claim 1
wherein the plurality of non-continuous susceptor conductors are provided at a predetermined dimensional spacing within the thermoplastic film.

4. The susceptor welding tape of claim 1
wherein the susceptor welding tape defines a plurality of welding tape slots.

5. The susceptor welding tape of claim 4
wherein each welding tape slot of the plurality of welding tape slots comprises a similar geometrical configuration.

6. The susceptor welding tape of claim 4
wherein a first grouping of the plurality of welding tape slots each comprise a first geometrical configuration and
wherein a second grouping of the plurality of welding tape slots each comprise a second geometrical configuration,
wherein the first geometrical configuration is different than the second geometrical configuration.

7. The susceptor welding tape of claim 4
wherein a first grouping of the plurality of welding tape slots each comprise a first size and
wherein a second grouping of the plurality of welding tape slots each comprise a second size,
wherein the first size is different than the second size.

8. The weld tape of claim 4,
wherein at least one of the plurality of welding tape slots comprises a rectangular slot.

9. The susceptor welding tape of claim 1,
wherein at least one of the plurality of non-continuous susceptor conductors comprises a smart susceptor conductor.

10. The susceptor welding tape of claim 9
wherein the smart susceptor conductor comprises an alloy comprising a composition in the range of from about 36% Ni to about 44% Ni in Fe.

11. The susceptor welding tape of claim 9
wherein the smart susceptor conductor comprises an alloy of approximately 80% Ni, 15% Fe, and 5% Mo.

12. The susceptor welding tape of claim 1, wherein
a material of at least one of the plurality of the non-continuous susceptor conductors is selected from the group consisting of copper, nickel, or nickel-coated copper.

13. The susceptor welding tape of claim 1, wherein
the thermoplastic film comprises a thermoplastic selected from the group consisting of polyyimide, polyetheretherketone (PEEK), or polyetherketoneketone (PEKK).

14. The welding tape of claim 1 wherein
each of the plurality of non-continuous susceptor conductors comprises a same length.

15. The welding tape of claim 1 wherein
the plurality of non-continuous susceptor conductors are arranged in a substantially uniform pattern within the thermoplastic film.

16. The welding tape of claim 1 wherein
the plurality of non-continuous susceptor conductors allow the resulting thermoplastic weld formed by the susceptor weld tape to be tuned to the desired engineering characteristic,
wherein the desired engineering characteristic comprises a conductivity of the resulting thermoplastic weld.

17. The welding tape of claim 1 wherein
the plurality of non-continuous susceptor conductors allow the resulting fusion bond formed by the susceptor weld tape to be tuned to the desired engineering characteristic,
wherein the desired engineering characteristic comprises a residual stress of the resulting thermoplastic weld.

18. The welding tape of claim 1 wherein
the plurality of non-continuous susceptor conductors allow the resulting a thermoplastic weld formed by the susceptor weld tape to be tuned to the desired engineering characteristic,
wherein the desired engineering characteristic comprises a moisture barrier of the resulting thermoplastic weld.

19. A method for thermoplastic welding using induction heating, comprising the steps of:
providing a first composite laminate;
providing a second composite laminate;
positioning a susceptor welding tape between a faying surface of the first composite laminate and a faying surface of the second composite laminate so as to define a bondline,
the susceptor welding tape comprising a plurality of non-continuous conductors embedded within a thermoplastic film;
heating the non-continuous conductors with an induction coil to about a melting temperature of the thermoplastic film and the faying surface of the first composite laminate and the faying surface of the second composite laminate;
melting the thermoplastic film and the faying surfaces of the first and second composite laminates in contact with the susceptor tape;
allowing the melted thermoplastic film and the faying surfaces to cool; and
resolidifying the thermoplastic film and the faying surfaces to form a thermoplastic weld between the first and second composite laminates.

20. The method of claim 19 further comprising the step of
exciting the induction coil by a power source having a frequency of approximately from about 150 KHz to about 300 KHz.

21. The method of claim 20 further comprising the step of
generating magnetic fields that are substantially parallel to an axis of the non-continuous conductors,
wherein the substantially parallel oscillating magnetic fields generate currents that travel circumferentially in the non-continuous conductors embedded within the thermoplastic film.

22. A method of fabricating a susceptor welding tape, the method comprising the steps of
determining at least one desired engineering characteristic of a thermoplastic weld to be formed by the susceptor welding tape, and
selecting the at least one desired engineering characteristic from a group of engineering characteristics comprising a thermoplastic weld conductivity, a thermoplastic weld bulk resistivity, or a thermoplastic weld moisture disruption requirement.

23. The method of claim 22 further comprising the step of:
defining a conductor material of the susceptor welding tape.

24. The method of claim 22 further comprising the step of:
defining a slot structure of the susceptor welding tape.

25. The method of claim 24, further comprising the step of
processing the susceptor welding tape in order to achieve the defined slot structure.

26. The method of claim 22 further comprising the step of:
defining a slot geometry of the susceptor welding tape.

27. The method of claim 26, further comprising the step of
processing the susceptor welding tape in order to achieve the defined slot geometry.
